(19) United States
(12) Patent Application Publication
(10) Pub. No.: US 2024/0357047 A1
(43) Pub. Date: Oct. 24, 2024

(54) COMMUNICATION APPARATUS, METHOD FOR CONTROLLING COMMUNICATION APPARATUS, AND STORAGE MEDIUM

(71) Applicant: CANON KABUSHIKI KAISHA, Tokyo (JP)

(72) Inventor: KEI TAKARABE, Kanagawa (JP)

(21) Appl. No.: 18/603,354

(22) Filed: Mar. 13, 2024

(30) Foreign Application Priority Data
Apr. 20, 2023 (JP) 2023-069399

(51) Int. Cl. H04N 1/00; G06F 3/12; G06F 8/65

(52) U.S. Cl. CPC H04N 1/00973; G06F 3/1204; G06F 3/123; G06F 3/1254; G06F 8/65; H04N 1/00413; G06F 3/1292

(57) ABSTRACT

A communication apparatus is capable of operating in a first mode that allows predetermined communication with an external apparatus and operating in a second mode in which the predetermined communication is not executed. The communication apparatus includes: an acceptance unit configured to accept from a user an activation operation for activating the communication apparatus; an activation unit configured to activate the communication apparatus in the first mode or the second mode based on acceptance of the activation operation; and a communication unit configured to automatically execute the predetermined communication without any user operation on the communication apparatus after the activation operation is accepted, based on the activation of the communication apparatus in the first mode, and also configured to not execute the predetermined communication based on the activation of the communication apparatus in the second mode.

### BACKGROUND OF THE INVENTION

### Field of the Invention

The present disclosure relates to a technology for updating firmware.

### Description of the Related Art

Communication apparatuses such as printers provide various services such as printing and scanning to users by communicating with external apparatuses such as a personal computer (PC) or a server. These services are implemented by the communication apparatus complying with the standards established by an IT vendor that provides a PC or server.

Japanese Patent Laid-Open No. 2017-194833 discloses a technology to restart an image forming apparatus, which communicates with an external apparatus, in a state where a network port for communicating with the external apparatus is disabled in a case where a predetermined error occurs in the image forming apparatus.

As communication apparatuses capable of communicating with external apparatuses become more widespread, there is a need for a technology that allows operating the communication apparatuses in an appropriate mode.

### SUMMARY OF THE INVENTION

A communication apparatus according to an aspect of the present disclosure is a communication apparatus capable of operating in a first mode that allows predetermined communication with an external apparatus and operating in a second mode in which the predetermined communication is not executed, comprising: an acceptance unit configured to accept from a user an activation operation for activating the communication apparatus; an activation unit configured to activate the communication apparatus in the first mode or the second mode based on acceptance of the activation operation; and a communication unit configured to automatically execute the predetermined communication without any user operation on the communication apparatus after the activation operation is accepted, based on the activation of the communication apparatus in the first mode, and also configured to not execute the predetermined communication based on the activation of the communication apparatus in the second mode.

Further features of the present invention will become apparent from the following description of exemplary embodiments with reference to the attached drawings.

### BRIEF DESCRIPTION OF THE DRAWINGS

FIG. 1 is a block diagram showing an example of a communication system including an external apparatus and a communication apparatus;

FIG. 2 is a sequence diagram showing a communication example in a case of transmitting log information;

FIG. 3 is a sequence diagram showing a communication example in a case of executing print processing;

FIG. 4 is a flowchart showing a processing example during activation;

FIG. 5 is a flowchart showing a processing example during activation;

FIG. 6 is a flowchart showing processing in a case where the communication apparatus is operating in a restricted mode;

FIGS. 7A and 7B are diagrams each showing an example of a screen displayed on a display unit of the communication apparatus;

FIGS. 8A to 8C are diagrams each showing an example of a screen displayed on the display unit of the communication apparatus; and

FIGS. 9A and 9B are diagrams each showing an example of a screen displayed on the display unit of the communication apparatus.

### DESCRIPTION OF THE EMBODIMENTS

Hereinafter, preferred embodiments of the present disclosure will be described in detail with reference to the accompanying drawings. Note that the following embodiments do not limit the subject matter of the present disclosure, and not all combinations of features described in the following embodiments are essential to the solution of the present disclosure. The same components will be described with the same reference numerals.

### First Embodiment

In the present embodiment, an example will be described where a communication apparatus can be appropriately used even if an error occurs. For example, a change in the operating specifications of an external apparatus such as a PC or a server may cause an error in the communication apparatus. In such a case, a problem may arise that the communication apparatus becomes no longer usable. Considering user convenience, it is preferable that minimum functions of the communication apparatus are available even if an error occurs in the communication apparatus. In a case where the error that occurred is a problem that needs to be solved on the communication apparatus side, it is required that the firmware of the communication apparatus be normally updated even under the situation where the problem has occurred.

In the present embodiment, the convenience is improved even in a case where an unexpected problem occurs in the communication apparatus. For example, even if an unexpected problem occurs in the communication apparatus, it is made possible to operate the communication apparatus with some functions available. It is also made possible to update the firmware of the communication apparatus even in a state where only some functions are available. This will be described in detail below.

### <System Configuration>

A communication system according to the present embodiment includes an external apparatus and a communication apparatus. In the present embodiment, description will be given taking a smartphone as an example of the external apparatus, but the present disclosure is not limited thereto. For example, various external apparatuses can be used, such as a mobile terminal, a personal computer (PC), a tablet terminal, a server, a personal digital assistant (PDA), or a digital camera. That is, the external apparatus may be any information processing apparatus. In the present embodiment, description will be given taking a printer as an example of the communication apparatus, but the present disclosure is not limited thereto, and various communication apparatuses capable of wireless communication with the external apparatus can be used. For example, the printer can be an ink jet printer, a full-color laser beam printer, a monochrome printer, or the like. The communication apparatus is also applicable not only to a printer but also to a copying machine, a facsimile machine, a mobile terminal, a smartphone, a notebook PC, a tablet terminal, a PDA, a digital camera, a music player device, a TV, a smart speaker, and the like. The communication apparatus is also applicable to a multifunction machine having multiple functions such as a copy function, a FAX function, and a print function. The communication apparatus is thus also a type of information processing apparatus.

In the present embodiment, if the information processing apparatus supports a function called Wi-Fi Easy Connect (hereinafter referred to as WEC) (registered trademark), the information processing apparatus can execute the function. WEC is a function to execute network setup for another apparatus, using Device Provisioning Protocol (hereinafter referred to as DPP) developed by Wi-Fi Alliance. The network setup for another apparatus is specifically connecting another apparatus to an access point to form a network. In WEC, communication is performed between an apparatus configured to operate in the role of “Configurator” (hereinafter referred to as Configurator apparatus) and an apparatus configured to operate in the role of “Enrollee” (hereinafter referred to as Enrollee apparatus).

In the present embodiment, the Configurator apparatus is an Initiator in the DPP, and the Enrollee apparatus is a Responder in the DPP. The Configurator apparatus obtains Bootstrapping information from the Enrollee apparatus. The Bootstrapping information includes, for example, identification information (MAC address and the like) of the Enrollee apparatus, public key information used for secure communication with the Enrollee apparatus, and the like.

The Configurator apparatus uses the obtained Bootstrapping information to perform wireless communication with the Enrollee apparatus. Specifically, the Configurator apparatus uses a public key included in the Bootstrapping information to communicate with the Enrollee apparatus, for example. The Configurator apparatus also generates a common key based on the information obtained through the communication, and transmits information encrypted using the common key to the Enrollee apparatus. The information transmitted here is, for example, connection information for connecting to an access point. The Enrollee apparatus establishes a wireless connection with the access point using the connection information received from the Configurator apparatus. In the network setup processing using WEC in the present embodiment, description will be given assuming that an information processing apparatus that supports WEC operates as the Configurator apparatus, and a communication apparatus that supports WEC operates as the Enrollee apparatus.

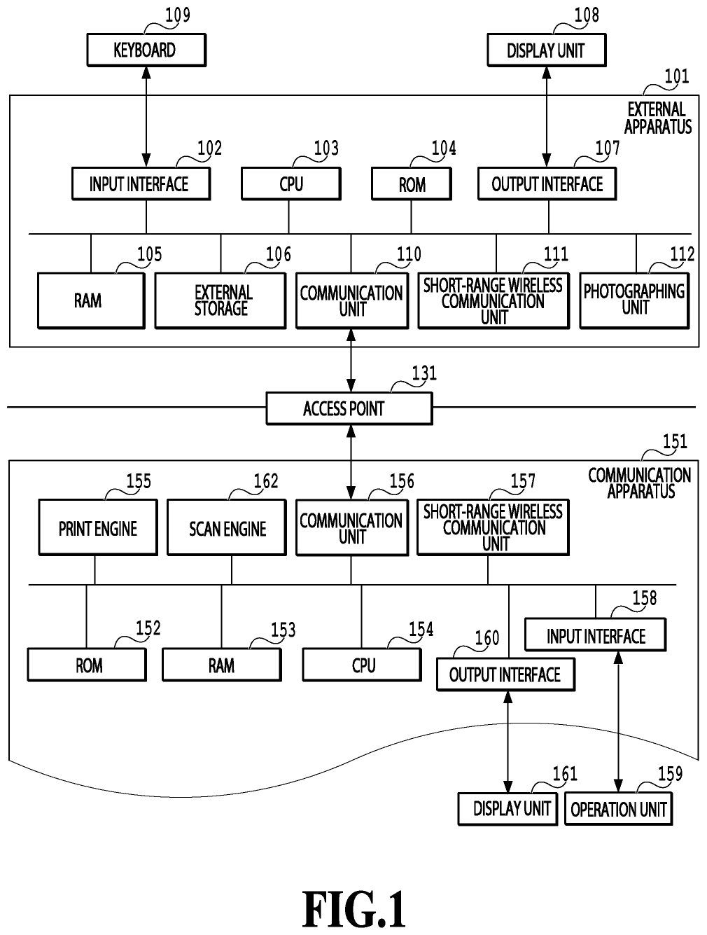

FIG. 1 is a block diagram showing an example of a communication system including an external apparatus 101 and a communication apparatus 151. In the present embodiment, the following configuration will be described as an example, but the functions are not limited to those shown in FIG. 1.

The external apparatus 101 includes an input interface 102, a CPU 103, a ROM 104, a RAM 105, an external storage 106, an output interface 107, a communication unit 110, a short-range wireless communication unit 111, and a photographing unit 112. The external apparatus 101 is connected to a display unit 108 and a keyboard 109 in FIG. 1, but may include the display unit 108 and the keyboard 109. The CPU 103, the ROM 104, the RAM 105, and the like form a computer of the external apparatus 101.

The input interface 102 is an interface configured to accept data input and operation instructions from a user operating an operation unit such as the keyboard 109. Note that the operation unit may be a physical keyboard, physical buttons, or the like, or may be a soft keyboard, soft buttons, or the like displayed on the display unit 108. That is, the input interface 102 may accept input (operation) from the user through the display unit 108.

The CPU 103 is a system control unit configured to control the entire external apparatus 101. The ROM 104 stores fixed data such as control programs executed by the CPU 103, data tables, or an embedded operating system (hereinafter referred to as OS) program. In the present embodiment, each control program stored in the ROM 104 performs software execution control, such as scheduling, task switching, or interruption processing, under the control of the embedded OS stored in the ROM 104.

The RAM 105 is composed of a static random access memory (SRAM) or the like that requires a backup power supply. The RAM 105 holds data using a primary battery for data backup (not shown), and thus can store important data such as program control variables in a non-volatile state. The RAM 105 is also provided with a memory area for storing setting information of the external apparatus 101, management data of the external apparatus 101, and the like. The RAM 105 is also used as a main memory and a work memory for the CPU 103.

The external storage 106 stores an application program for executing network setup for the communication apparatus 151 (hereinafter referred to as a setting application), a printing information generation program for generating printing information that can be interpreted by the communication apparatus 151, and the like. The setting application is an application program for setting an access point to which the communication apparatus 151 is connected, using WEC or the like. The setting application may also include other functions besides the network setup function. For example, the setting application may also include a function to cause the communication apparatus 151 to execute printing, a function to cause the communication apparatus 151 to scan a document set in the communication apparatus 151, a function to check the state of the communication apparatus 151, or the like. The setting application is installed from an external server through Internet communication via the communication unit 110, for example, and is stored in the external storage 106. The external storage 106 stores various programs such as an information transmission and reception control program for performing transmission and reception with the communication apparatus 151 connected via the communication unit 110 and various information used by these programs.

The output interface 107 is an interface configured to control the display unit 108 to display data or notify the state of the external apparatus 101. The display unit 108 includes a light emitting diode (LED), a liquid crystal display (LCD), and the like, and is configured to display data and notify the state of the external apparatus 101.

The communication unit 110 connects to an apparatus such as the communication apparatus 151 or the access point 131 to perform data communication. For example, the communication unit 110 can connect to an access point (not shown) inside the communication apparatus 151. Connecting the communication unit 110 to the access point (not shown) in the communication apparatus 151 allows the external apparatus 101 and the communication apparatus 151 to communicate with each other. The communication unit 110 may communicate directly with the communication apparatus 151 through wireless communication, or may communicate with the communication apparatus 151 via an external apparatus present outside the external apparatus 101 or the communication apparatus 151. The external apparatus includes an external access point (such as the access point 131) present outside the external apparatus 101 and the communication apparatus 151, or a device that can relay communication other than the access point. In the present embodiment, it is assumed that the wireless communication method used by the communication unit 110 is Wi-Fi (Wireless Fidelity) (registered trademark), which is a communication standard that complies with the IEEE802.11 series, and that the above-described WEC is executed through communication by the communication unit 110. Examples of the access point 131 include devices such as a wireless LAN router. In the present embodiment, a method in which the external apparatus 101 and the communication apparatus 151 are directly connected without using any external access point is referred to as a direct connection method. On the other hand, a method in which the external apparatus 101 and the communication apparatus 151 are connected via an external access point is referred to as an infrastructure connection method.

The short-range wireless communication unit 111 is configured to perform data communication by wirelessly connecting to an apparatus such as the communication apparatus 151 at close range, and performs communication using a communication method different from that of the communication unit 110. The short-range wireless communication unit 111 is connectable to a short-range wireless communication unit 157 in the communication apparatus 151. Examples of the communication method include Near Field Communication (NFC), Bluetooth (registered trademark) Classic, Bluetooth Low Energy (BLE), Wi-Fi Aware, and the like.

In the present embodiment, the external apparatus 101 executes WEC using the OS of the external apparatus 101, based on an instruction to execute network setup processing from the setting application.

Next, the configuration of the communication apparatus 151 will be described. The communication apparatus 151 includes a ROM 152, a RAM 153, a CPU 154, a print engine 155, a scan engine 162, a communication unit 156, the short-range wireless communication unit 157, an input interface 158, and an output interface 160. FIG. 1 shows an example where the communication apparatus 151 is connected to an operation unit 159 and a display unit 161, but the communication apparatus 151 may include the operation unit 159 and the display unit 161. The ROM 152, the RAM 153, the CPU 154, and the like form a computer of the communication apparatus 151.

The communication unit 156 has an access point for connecting to an apparatus such as the external apparatus 101, as an internal access point of the communication apparatus 151. This internal access point can be connected to the communication unit 110 of the external apparatus 101. Enabling the internal access point by the communication unit 156 causes the communication apparatus 151 to operate as an access point. The communication unit 156 may be directly wirelessly connected to the external apparatus 101 or may be wirelessly connected via the access point 131. In the present embodiment, it is assumed that the wireless communication method used by the communication unit 156 is a communication standard that complies with the IEEE802.11 series. In the following description, Wi-Fi (Wireless Fidelity) (registered trademark) (Wi-Fi communication) is a communication standard that complies with the IEEE802.11 series. If the communication apparatus 151 supports WEC, the above-mentioned WEC is executed through communication by the communication unit 156. The communication unit 156 may include hardware that functions as an access point, or may operate as an access point using software to function as an access point.

The communication apparatus 151 according to the present embodiment can operate in an infrastructure mode and a peer-to-peer (P2P) mode (direct connection mode) as modes for communication using the communication unit 156.

The infrastructure mode is a mode in which the communication apparatus 151 communicates with another apparatus such as the external apparatus 101 via an external device (for example, the access point 131) that forms a network. A connection with an external access point established by the communication apparatus 151 operating in the infrastructure mode is referred to as an infrastructure connection (hereinafter referred to as infrastructure connection). In the present embodiment, the communication apparatus 151 operates as a slave station and the external access point operates as a master station in the infrastructure connection. In the present embodiment, the master station is an apparatus that determines a communication channel used in a network to which the master station belongs, and the slave station is an apparatus that does not determine a communication channel used in a network to which the slave station belongs, but uses the communication channel determined by the master station.

The P2P mode is a mode in which the communication apparatus 151 directly communicates with another apparatus such as the external apparatus 101 without using any external device (for example, the access point 131) that forms a network. In the present embodiment, it is assumed that the P2P mode includes an AP mode in which the communication apparatus 151 operates as an access point. It is assumed that connection information (SSID and password) on an access point enabled within the communication apparatus 151 during the AP mode can be set arbitrarily by the user. The P2P mode may include, for example, a WFD mode for the communication apparatus 151 to perform Wi-Fi direct (WFD) communication. Which one of a plurality of WFD-compatible devices operates as a master station is determined according to a sequence called Group Owner Negotiation, for example. Note that the parent station may be determined without executing Group Owner Negotiation. An apparatus that is a WFD-compatible device and serves as a master station is called a Group Owner. A direct connection with another apparatus established by the communication apparatus 151 operating in the P2P mode is referred to as a “direct connection.” In the present embodiment, the communication apparatus 151 operates as a master station and another apparatus operates as a slave station in the direct connection.

In the embodiment, the communication apparatus 151 can operate in a network setup mode, which is a mode for executing network setup of the communication apparatus 151, upon receiving a predetermined operation from the user. In a case of operating in the network setup mode, the communication apparatus 151 uses the communication unit 156 to operate as a setup access point that is enabled while operating in the network setup mode. The setup access point is different from the access point that is enabled in the AP mode described above. The SSID of the setup access point includes a predetermined character string that can be recognized by the setting application of the external apparatus 101. The setup access point is also an access point that does not require a password for connection. The communication apparatus 151 operating in the network setup mode uses a predetermined communication protocol (setup communication protocol) in communication with the external apparatus 101 connected to the setup access point. Specifically, the setup communication protocol is a simple network management protocol (SNMP) or a hypertext transfer protocol (HTTP), for example. The communication apparatus 151 stops operating in the network setup mode and disables the setup access point when a predetermined time elapses after starting the operation in the network setup mode. This is because, if the setup access point is enabled for a long time, since it is an access point that does not require a password as described above, it increases the possibility of inappropriate apparatuses requesting connection. Note that the setup access point may be an access point that requires a password. In that case, a password used to connect to the setup access point is a fixed password (that cannot be changed by the user) that is previously known to the setting application.

The short-range wireless communication unit 157 is configured for short-range wireless connection with an apparatus such as the external apparatus 101, and can be connected to the short-range wireless communication unit 111 in the external apparatus 101, for example. Examples of the communication method include NFC, Bluetooth Classic, BLE, Wi-Fi Aware, and the like.

The RAM 153 is composed of an SRAM or the like that requires a backup power supply. The RAM 153 holds data using a primary battery for data backup (not shown), and thus can store important data such as program control variables in a non-volatile state. The RAM 153 is also provided with a memory area for storing setting information of the communication apparatus 151, management data of the communication apparatus 151, and the like. The RAM 153 is also used as a main memory and a work memory for the CPU 154 to store a reception buffer for temporarily storing printing information received from the external apparatus 101 or the like, and various types of information.

The ROM 152 stores fixed data such as control programs executed by the CPU 154, data tables, and the OS program. The ROM 152 also stores firmware of the communication apparatus 151 to be described later. In the present embodiment, each control program including the firmware stored in the ROM 152 performs software execution control, such as scheduling, task switching, and interruption processing, under the control of the embedded OS stored in the ROM 152.

The CPU 154 is a system control unit configured to control the entire communication apparatus 151. The print engine 155 forms an image on a printing medium such as paper by applying a printing agent such as ink onto the printing medium based on the information stored in the RAM 153 or a print job received from the external apparatus 101 or the like, and then outputs the print result. The print job transmitted from the external apparatus 101 or the like generally has a large amount of data, which requires a communication method capable of high-speed communication to be used for communication of the print job. Therefore, the communication apparatus 151 receives the print job via the communication unit 156, which is capable of faster communication than the short-range wireless communication unit 157.

The scan engine 162 reads image data and document data from a set document or the like, based on input from the operation unit 159 or a scan job received from the external apparatus 101 or the like. The read data is stored in the RAM 153 or transmitted to the external apparatus 101 or the like as a scan result. The scan result transmitted from the communication apparatus 151 to the external apparatus 101 or the like generally has a large amount of data, which requires a communication method capable of high-speed communication to be used for communication of such results. Therefore, the communication apparatus 151 transmits the scan result via the communication unit 156, which is capable of faster communication than the short-range wireless communication unit 157.

The communication apparatus 151 may be equipped with a memory such as an external HDD or an SD card as an optional device, and the information stored in the communication apparatus 151 may be stored in the memory.

The input interface 158 is an interface for accepting data input and operation instructions from the user operating the operation unit 159 such as physical buttons. Note that the operation unit may be a soft keyboard, soft buttons, or the like displayed on the display unit 161. That is, the input interface 158 may accept input from the user via the display unit 161.

The output interface 160 is an interface configured to control the display unit 161 to display data or notify the state of the communication apparatus 151. The display unit 161 includes a light emitting diode (LED), a liquid crystal display (LCD), and the like, and is configured to display data and notify the state of the communication apparatus 151.

### Example of Communication Between Communication Apparatus 151 and External Apparatus 101

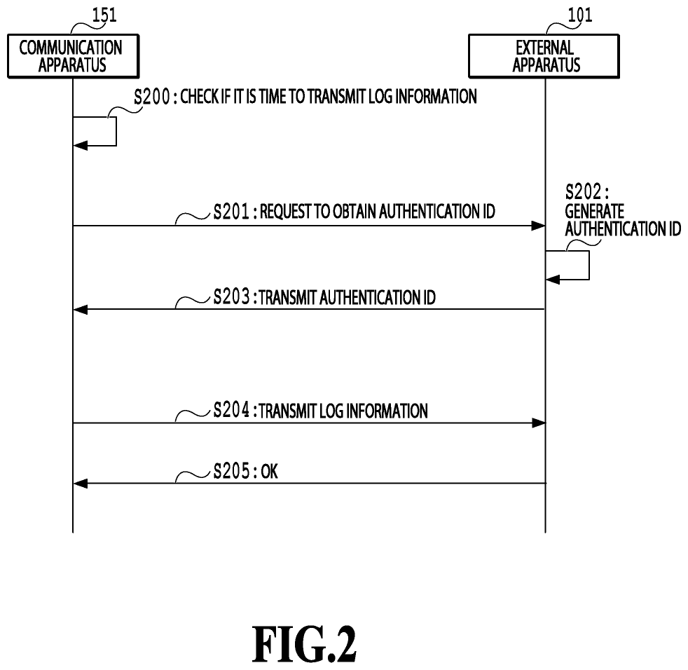

FIG. 2 is a sequence diagram showing a communication example in a case of transmitting log information between the communication apparatus 151 and the external apparatus 101. In the example of FIG. 2, the external apparatus 101 operates as a server for collecting log information, and the communication apparatus 151 transmits a usage status of the user and an operating status of the communication apparatus 151 to the external apparatus 101 as log information. The log information is stored in the RAM 153 of the communication apparatus 151. The log information is transmitted to the external apparatus 101 that operates as the server to collect the log information, and the log information is used for analysis and the like to improve the specifications of the communication apparatus 151.

The processing of the communication apparatus 151 in the sequence shown in FIG. 2 is realized by the CPU 154 of the communication apparatus 151 reading a program stored in the ROM 152 into the RAM 153 and executing the program. The processing of the external apparatus 101 in the sequence shown in FIG. 2 is realized by the CPU 103 of the external apparatus 101 reading a program stored in the ROM 104 into the RAM 105 and executing the program. The symbol “S” in the description of each process means a step in the sequence diagram (hereinafter, the same applies to sequence diagrams and flowcharts in this specification). The sequence shown in FIG. 2 is executed regularly or irregularly at a predetermined timing.

In S200, the communication apparatus 151 checks if it is time to transmit log information. The timing for transmitting the log information is, for example, when the communication apparatus 151 is powered on. If determining that it is time to transmit the log information, the communication apparatus 151 automatically transmits an authentication ID acquisition request to the external apparatus 101 in S201, regardless of whether or not there is a user operation. In the present embodiment, the authentication ID acquisition request is transmitted through HTTP communication, and the authentication ID refers to cookie information. The authentication ID is used for the external apparatus 101 to uniquely identify the communication apparatus 151 in an environment where a plurality of communication apparatuses 151 and the external apparatus 101 are connected, for example. Therefore, in response to the authentication ID acquisition request, the external apparatus 101 generates an authentication ID so that it has a unique value for each communication apparatus 151 in S202. After generating the authentication ID, the external apparatus 101 transmits the authentication ID to the communication apparatus 151 in S203.

Upon receiving the authentication ID from the external apparatus 101 in S203, the communication apparatus 151 stores the authentication ID in the RAM 153 of the communication apparatus 151. In S204, the communication apparatus 151 then transmits log information to the external apparatus 101. In the case of transmitting the log information, the communication apparatus 151 transmits data obtained by adding the authentication ID to the log information to the external apparatus 101. Upon normally receiving the log information, the external apparatus 101 transmits information indicating the normal reception of the log information to the communication apparatus 151 in S205.

Next, a case where an error occurs in the communication apparatus 151 will be described. In FIG. 2, a case is considered where the external apparatus 101 transmits an authentication ID exceeding a specified size in the case of transmitting the authentication ID to the communication apparatus 151 in S203, for example. To store the authentication ID in the RAM 153, the communication apparatus 151 secures in advance an area corresponding to the upper limit size specified for the authentication ID. However, there are cases where an authentication ID exceeding the specified size is transmitted from the external apparatus 101 to the communication apparatus 151. In this case, if the authentication ID is accidentally stored beyond the secured area, the operation of the communication apparatus 151 may become unstable or the communication apparatus 151 may shut down. In this case, in the present embodiment, the communication apparatus 151 automatically starts obtaining an authentication ID as the user turning on the power of the communication apparatus 151, which easily causes the communication apparatus 151 to shut down.

In the present embodiment, the log information transmission timing has been described as being the timing when the communication apparatus 151 is powered on, but is not limited thereto. For example, the timing may be when a certain period of time has elapsed since the last transmission of log information, or after the completion of operation of each service such as printing.

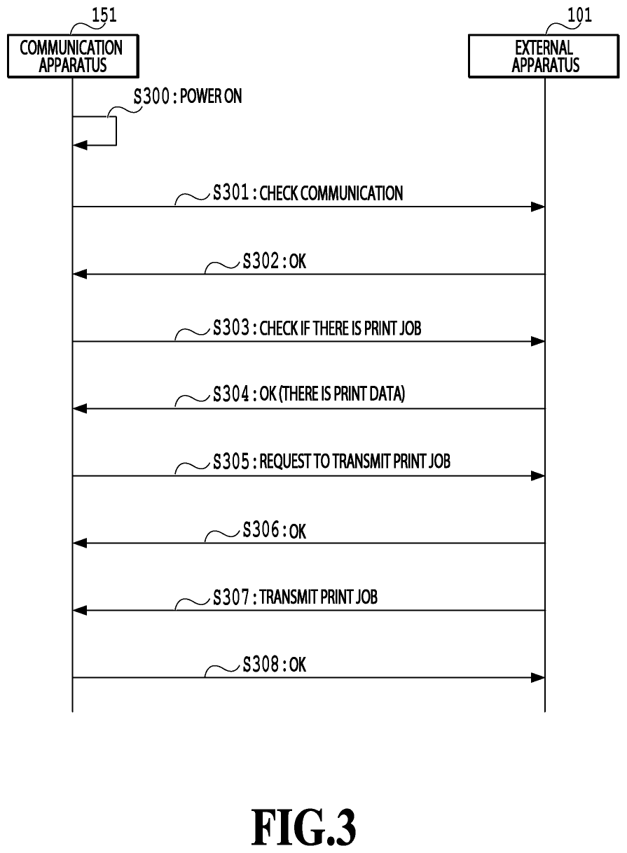

FIG. 3 is a sequence diagram showing a communication example in a case of executing print processing between the communication apparatus 151 and the external apparatus 101. In the example of FIG. 3, the external apparatus 101 operates as a server that can register a print job, and the communication apparatus 151 can execute printing by receiving a print job from the external apparatus 101. Note that the external apparatus 101 shown in FIG. 2 may be the same as or different from the external apparatus 101 shown in FIG. 3. The registration of a print job to the external apparatus 101 is performed by another apparatus (not shown) that is different from the external apparatus 101 and operates as a PC. The sequence shown in FIG. 3 is started when the communication apparatus 151 is powered on.

In S300, the communication apparatus 151 detects that the communication apparatus 151 is powered on. Once powered on, the communication apparatus 151 checks communication with the external apparatus 101 with a print job registered therein. That is, the communication apparatus 151 checks communication with the external apparatus 101 in S301 as a preliminary preparation for checking if there is a print job registered. In this communication check, the communication apparatus 151 transmits a request to a URL (Uniform Resource Locator) for accessing the external apparatus 101, and checks if a response comes back normally. This URL is a value specified by the external apparatus 101. If the communication is successful as a result of checking the communication with the external apparatus 101 by the communication apparatus 151 in S301, the external apparatus 101 sends a response indicating that the communication is successful to the communication apparatus 151 in S302.

Upon successful completion of the communication check with the external apparatus 101, the communication apparatus 151 checks if there is a print job registered with the external apparatus 101 in S303. The communication apparatus 151 may automatically check if there is a print job registered after checking the communication with the external apparatus 101, or may check it using some user operation as a trigger. If there is a print job registered with the external apparatus 101, information indicating that there is a print job registered is transmitted from the external apparatus 101 to the communication apparatus 151 in step S304.

If it is confirmed in S304 that there is a print job registered, the communication apparatus 151 transmits a print job (print data) transmission request to the external apparatus 101 in S305. Upon receiving the print job transmission request from the communication apparatus 151, if the print job can be transmitted without any problem, the external apparatus 101 transmits information indicating that the print job can be transmitted in step S306. In S307, the external apparatus 101 then transmits the print job to the communication apparatus 151. The print job includes not only printing data but also print setting information such as paper information, quality, single-sided, double-sided, or a paper feed port. Upon successfully receiving the print job, the communication apparatus 151 transmits information indicating the successful reception to the external apparatus 101 in step S308, and executes the print processing.

Next, a case where an error occurs in the communication apparatus 151 will be described. In S301 and S302 of FIG. 3, a case where communication is checked between the communication apparatus 151 and the external apparatus 101 is taken as an example. In S301, the communication apparatus 151 transmits a request to the URL specified by the external apparatus 101. Here, if the URL of the request destination has been changed due to a change in the operation specifications of the external apparatus 101, for example, the external apparatus 101 transmits a new request destination URL to the communication apparatus 151 in S302. The communication apparatus 151 has an area previously secured in the RAM 153 to store the received new request destination URL. In this event, if the transmitted new URL exceeds the specified size and the communication apparatus 151 saves the URL beyond the area size previously secured in the RAM 153, memory corruption occurs. If memory corruption occurs, the operation of the communication apparatus 151 may become unstable or the communication apparatus 151 may shut down. In this case, the communication apparatus 151 automatically checks the communication with the external apparatus 101 as the user powers on the communication apparatus 151 in the present embodiment, which easily causes the communication apparatus 151 to shut down.

Hereinafter, description will be given of a process for appropriately making the communication apparatus usable even in a case where an error occurs, which has been described taking FIGS. 2 and 3 as an example.

### <Flowchart During Activation>

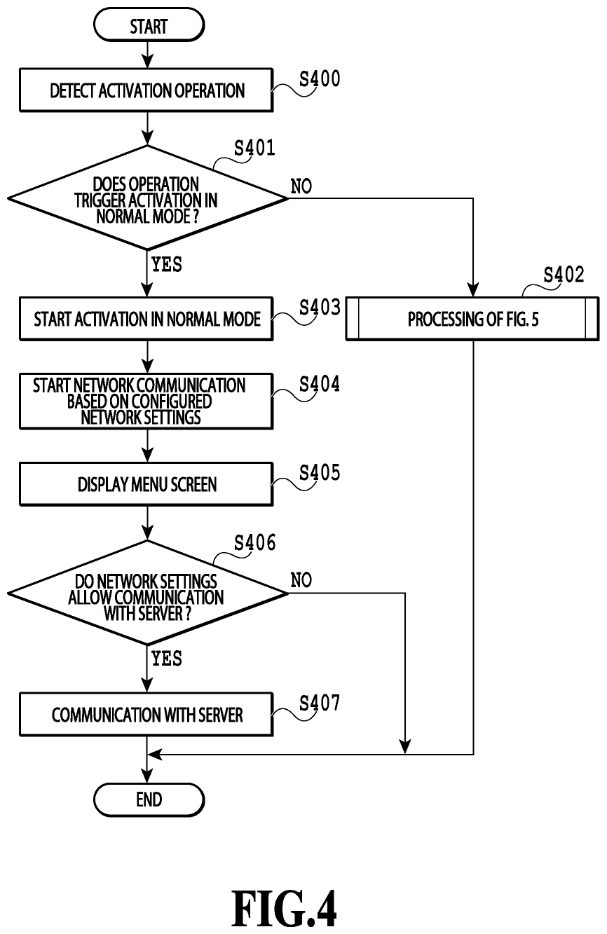

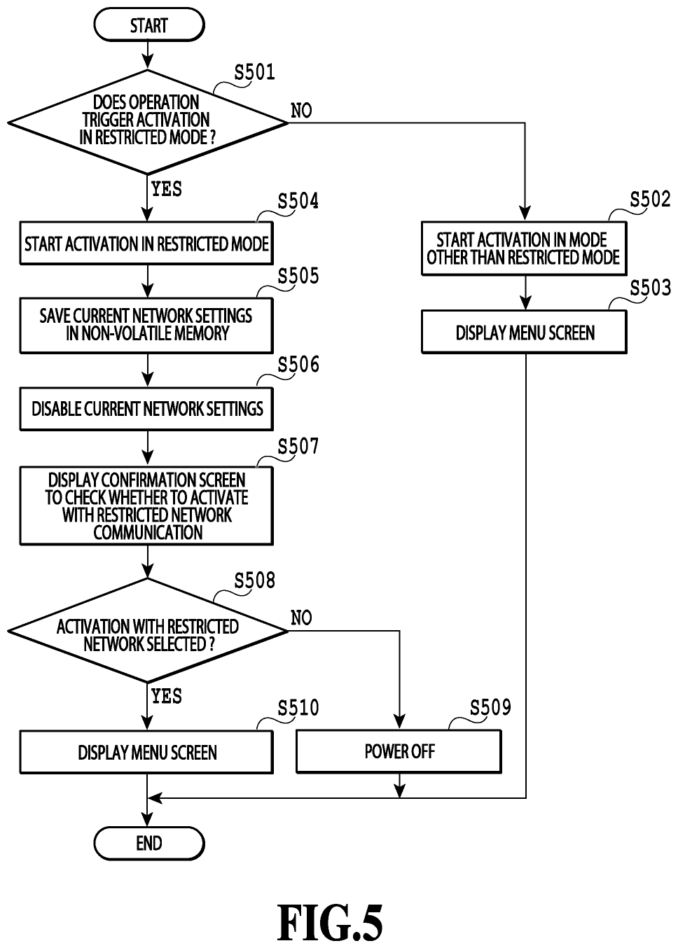

FIGS. 4 and 5 are flowcharts showing an example of processing during activation, which is executed in the communication apparatus 151 according to the present embodiment. As described above, the flowcharts shown in FIGS. 4 and 5 are realized by the CPU 154 of the communication apparatus 151 reading a program stored in the ROM 152 into the RAM 153 and executing the program. FIG. 4 shows processing executed as the user powers on the communication apparatus 151.

S400 is a process at the start of this flowchart. That is, in S400, the CPU 154 detects that the user has performed an activation operation on the communication apparatus 151 to start the communication apparatus 151. In S401, the CPU 154 determines whether the activation operation performed by the user in S400 is an operation that triggers activation in a normal mode. Here, the normal mode is a mode in which all functions of the communication apparatus 151 can be used. In other words, the normal mode is a mode in which no functions are restricted. Modes other than the normal mode include, for example, a restricted mode in which the communication apparatus 151 operates with some functions restricted, an inspection mode used only at the production site of the communication apparatus 151, and the like.

If it is determined in S401 that the operation does not trigger the activation in the normal mode, the processing proceeds to S402. In S402, processing of FIG. 5 to be described later is performed. The CPU 154 then ends the processing of the flowchart shown in FIG. 4. On the other hand, if it is determined in S401 that the operation triggers the activation in the normal mode, the CPU 154 proceeds to S403.

In S403, the CPU 154 starts the activation process in the normal mode. The activation process in the normal mode includes, for example, initialization processing of variables and areas in software control of the communication apparatus 151 as well as initialization processing regarding hardware such as the print engine 155 of the communication apparatus 151. In other words, this activation process is necessary for the communication apparatus 151 to operate normally.

In S404, the CPU 154 starts network communication processing of the communication apparatus 151 based on network settings set by the user. The network settings include, for example, enable setting indicating whether to establish a wireless infrastructure connection with the access point 131 or enable setting indicating whether to establish a P2P connection with the external apparatus 101. In a case of establishing a wireless infrastructure connection between the communication apparatus 151 and the access point 131, the SSID and password of the access point 131 to be connected need to be set by the user. Note that the SSID and password of the access point 131 to which wireless infrastructure connection has been made are stored in the communication apparatus 151. In a case of establishing a wireless infrastructure connection to the access point 131 for the first time, the user sets an SSID and a password, and these SSID and password are stored in the communication apparatus 151.

For example, if the wireless infrastructure connection is enabled, the CPU 154 searches for a nearby access point with the internally stored SSID in S404. On the other hand, if the wireless infrastructure connection is disabled, the CPU 154 does not search for the access point with the internally stored SSID in S404. If the wireless P2P connection is enabled, the CPU 154 causes the communication apparatus 151 to operate as a master station (that is, an access point) and broadcasts Beacon information and the like to the surrounding area in S404. On the other hand, if the wireless P2P connection is disabled, the communication apparatus 151 does not operate as the master station.

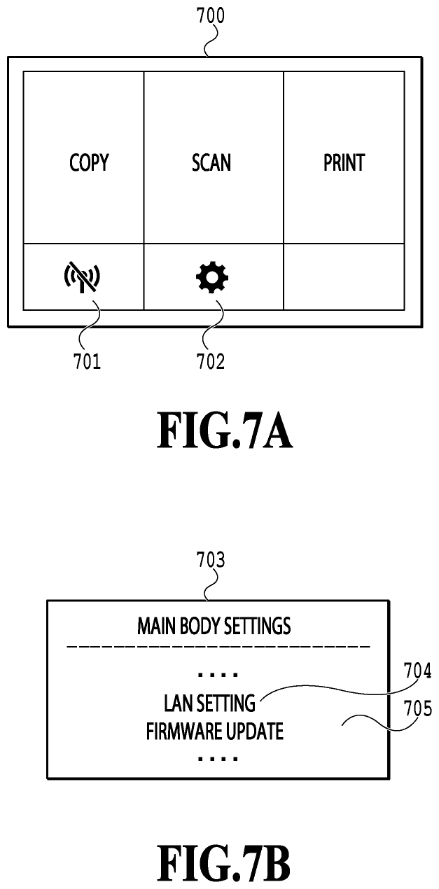

Upon completion of the processing necessary to activate the communication apparatus 151 in S403 and S404, the CPU 154 displays a menu screen on the display unit 161 in S405. This allows the user to issue operation instructions to the communication apparatus 151 via the operation unit 159. The menu screen will be described in detail later with reference to FIG. 7.

After displaying the menu screen on the display unit 161 in S405, the CPU 154 determines in S406 whether or not the network settings allow communication with an external server, regardless of whether there is any user operation on the communication apparatus 151 after the activation of the communication apparatus 151. In other words, the CPU 154 automatically checks if the network settings allow communication with the external server without any user operation on the communication apparatus 151 after the activation of the communication apparatus 151. The network settings that allow communication with the external server refer to settings that allow infrastructure connection to the access point 131. If the CPU 154 determines in S406 that the network settings allow communication with the external server, the CPU 154 communicates with the external server in S407. In the present embodiment, the communication with the external server executed in S407 includes the communication with the external apparatus 101 described in FIG. 2 or 3, for example. Note that the communication with the external server executed in S407 may be not all but only part of the communication with the external apparatus 101 described in FIG. 2 or 3. Specifically, as for the communication described in FIG. 2, for example, only S201 and S202 may be executed in S407, and S204 and S205 may be executed at another timing. Note that S201 and S202 may also be executed again at the other timing. As for the communication described in FIG. 3, for example, only S301 and S302 may be executed in S407, and S303 to S308 may be executed at another timing. Note that S301 and S302 may also be executed again at the other timing. The communication with the external server executed in S407 may be communication other than the communication with the external apparatus 101 described in FIG. 2 or 3. The communication executed in S407 may be communication with the external apparatus 101 other than the external server or communication with another apparatus, instead of the communication with the external server. S405 and S406 may be performed in reverse processing order, or may be performed simultaneously.

Next, with reference to FIG. 5, description will be given of the process of S402, that is, the process in a case where an operation is performed that triggers activation in a mode other than the communication mode. In FIG. 5, an operation flow in a case where the communication apparatus 151 is activated in a restricted mode will be mainly described.

In S501, the CPU 154 determines whether the activation operation performed by the user in S400 is an operation that triggers activation in the restricted mode. In the present embodiment, the restricted mode refers to a mode in which the communication apparatus 151 is operated with its network communication function restricted. However, the communication apparatus 151 may be operated with functions other than the network communication function restricted. Specifically, the network communication function restricted here is a communication function based on the IEEE802.11 series or a communication function based on a wired LAN. In the present embodiment, the network communication function is restricted in the restricted mode. Therefore, the communication apparatus 151 operating in the restricted mode can no longer receive a print job from the outside through a network and execute printing based on the print job. However, for example, the communication apparatus 151 operating in the restricted mode can perform printing based on a print job saved in advance by the communication apparatus 151 and printing based on image data stored in an external memory attached to the communication apparatus 151. The operation that triggers activation in the restricted mode is a user operation that is different from the operation that triggers activation in the normal mode described with reference to FIG. 4. For example, the operation that triggers activation in the normal mode is an operation in which the user presses a power button (not shown) disposed in the operation unit 159 of the communication apparatus 151 and then releases an operator such as a finger from the power button. The operation that triggers activation in the restricted mode is, for example, the following operation. Specifically, after the power button is continuously pressed for a predetermined period of time or more, a predetermined physical button (not shown) other than the power button or a predetermined area on the display unit 161 is pressed with the power button being held down, and then the operator is released from the power button. As a matter of course, this is just an example, and other operations may be used. The operation that triggers activation in the restricted mode of the communication apparatus 151 having a predetermined physical button may be different in operation content from the operation that triggers activation in the restricted mode of the communication apparatus 151 having no predetermined physical button.

If it is determined in S501 that the operation does not trigger the activation in the restricted mode, the CPU 154 proceeds to S502. In S502, the CPU 154 starts an activation process in a mode other than the restricted mode. That is, in S502, the activation process is started in another mode (for example, an inspection mode) that is different from the normal mode or restricted mode. In S503, the CPU 154 then displays a menu screen on the display unit 161. The CPU 154 then ends the processing shown in FIG. 5. Note that if the communication apparatus 151 does not have a mode other than the normal mode and the restricted mode, the processing may start from S504 by omitting the main determination in this flowchart.

On the other hand, if it is determined in S501 that the operation triggers the activation in the restricted mode, the CPU 154 proceeds to S504. In S504, the CPU 154 starts an activation process for operating the communication apparatus 151 in the restricted mode. In the present embodiment, the restricted mode is a mode in which the communication apparatus 151 is operated with only network communication restricted. Therefore, the activation process in the restricted mode in S504 is the same as the activation process in the normal mode in S403 in FIG. 4. However, the present disclosure is not limited thereto. For example, if the scanner function of the communication apparatus 151 is restricted in the restriction mode, initialization processing of the scan engine 162 does not need to be performed in the activation process in the restriction mode in S504. That is, in S504, an activation process that is different from the activation process in the normal mode may be performed.

After starting the activation process in the restricted mode in S504, the CPU 154 stores the network settings of the communication apparatus 151 set by the user in a non-volatile memory (for example, the ROM 152) in S505. Here, the network settings refer to enable/disable setting for infrastructure connection and enable/disable setting for P2P connection. The enable/disable setting is the setting indicating whether the connection is enabled or disabled. The infrastructure connection enable/disable setting includes wireless infrastructure connection enable/disable setting and wired infrastructure connection enable/disable setting. The P2P connection is wireless P2P connection. The wireless infrastructure connection enable/disable setting is, in other words, infrastructure mode enable/disable setting. The P2P connection enable/disable setting is, in other words, direct connection mode enable/disable setting. In S505, these current network settings are saved in the non-volatile memory. For example, network settings such that the infrastructure connection is enabled and the P2P connection is disabled are stored in the non-volatile memory. As described above, once the setting values necessary for network connection, such as the SSID, password, or DNS, are set, those values remain stored in the non-volatile memory. The network settings stored in S504 are enable/disable settings for each network connection. The setting value of the network settings stored in S504 is also referred to as a first setting value (first value).

Next, in S506, the CPU 154 automatically disables the network settings described above to restrict network communication of the communication apparatus 151. That is, network settings that are already disabled are not changed, and network settings that are enabled are changed to disabled. In the restricted mode of the present embodiment, only the network settings are disabled. Therefore, it is possible to communicate with the external apparatus 101 using a connection method other than the network communication, such as a universal serial bus (USB). The setting value of the network setting disabled in S506, which is changed from the first setting value, is also referred to as a second setting value (second value). After the first setting value is saved and the communication apparatus 151 is activated in the restricted mode, the communication apparatus 151 ends its operation in the restricted mode by turning off the power of the communication apparatus 151 or the like. Then, the communication apparatus 151 is activated again in the normal mode by performing an operation to activate the communication apparatus 151 in the normal mode after the communication apparatus 151 ended its operation in the restricted mode as describe above. In this case, the setting value of the network setting of the communication apparatus 151 is changed again from the second setting value set in S506 back to the first setting value saved in S505.

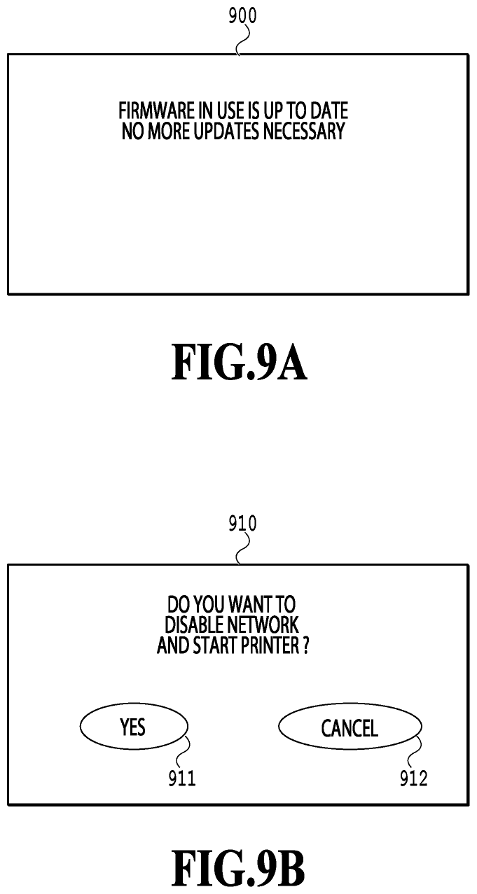

Next, in S507, the CPU 154 displays a confirmation screen on the display unit 161. In S506, the communication apparatus 151 automatically disables the network settings. Therefore, in S507, a process is performed to display a confirmation screen on the display unit 161 for checking with the user whether the communication apparatus 151 may operate in the restricted mode. That is, a process is performed to display a confirmation screen on the display unit 161 for checking whether to activate the communication apparatus 151 with the network communication restricted. This confirmation screen is displayed assuming that the user accidentally performs an operation to operate the communication apparatus 151 in the restricted mode, even though the user wanted to operate the communication apparatus 151 in the normal mode. The confirmation screen will be described in detail later with reference to FIG. 9.

Next, in S508, the CPU 154 determines the operation selected by the user on the confirmation screen displayed in S507. That is, the CPU 154 determines whether the user has selected to activate the communication apparatus 151 with the restricted network. In other words, the CPU 154 determines whether the user has selected to operate the communication apparatus 151 in the restricted mode. If determining that the user does not select to activate the communication apparatus 151 with the restricted network, the CPU 154 proceeds to S509. In S509, the CPU 154 performs control to prevent the communication apparatus 151 from operating in the restricted mode. Specifically, the CPU 154 executes processing for turning off the communication apparatus 151. In other words, since the user has mistakenly performed an operation to operate the communication apparatus 151 in the restricted mode, the CPU 154 performs the processing to turn off the communication apparatus 151. In this event, processing of turning off the power may be performed after displaying precautions for activation in the normal mode on the display unit 161. When the power is turned on again after that, the processing shown in the flowchart of FIG. 4 is performed again. In this event, if a user operation for activation in the normal mode is performed, the processing proceeds to S403 and thereafter for the activation in the normal mode. In S509, the communication apparatus 151 may be activated in the normal mode without turning off its power.

On the other hand, if determining that the user has selected to activate the communication apparatus 151 with the restricted network, the CPU 154 proceeds to S510. In S510, the CPU 154 displays a menu screen on the display unit 161. This menu screen will be described in detail later with reference to FIG. 7. Then, the CPU 154 ends the processing of the flowchart shown in FIG. 5 (that is, the processing of the flowchart of FIG. 4). In this state, the activation process in the restricted mode is completed, and thus the communication apparatus 151 is operating in the restricted mode. While operating in the restricted mode, although some functions are restricted, the communication apparatus 151 can perform various operations using unrestricted functions.

### <Flowchart During Operation in Restricted Mode>

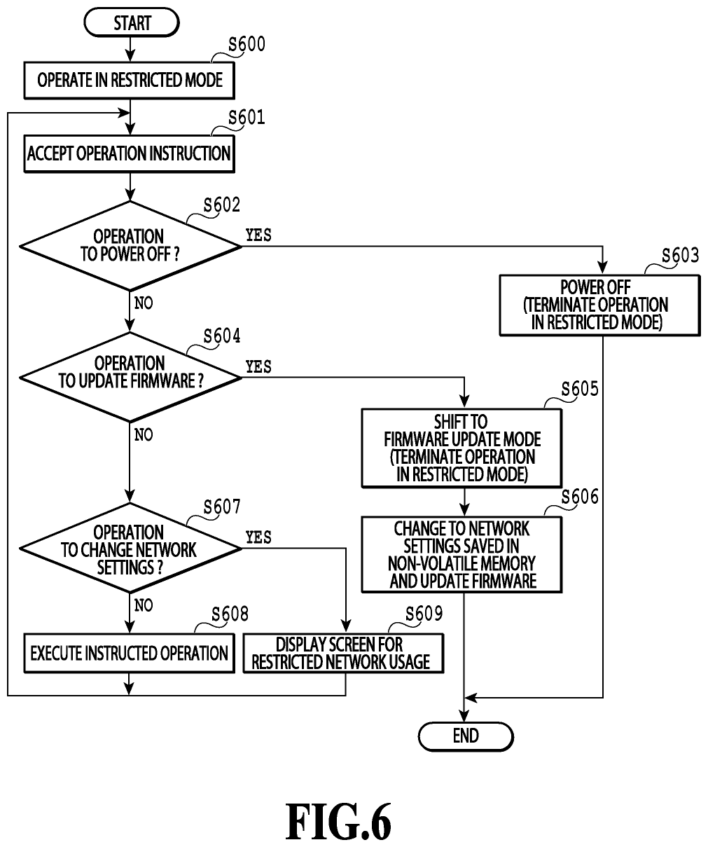

FIG. 6 is a flowchart showing processing in a case where the communication apparatus 151 is operating in the restricted mode. With reference to FIG. 6, description will be given of an operation flow in a case where the communication apparatus 151 accepts a setting change operation, a firmware update operation or the like by the user while operating in the restricted mode.

First, it is assumed that the communication apparatus 151 is operating in a restricted mode, as shown in S600. Specifically, in the present embodiment, S600 corresponds to a timing state after starting the operation in the restricted mode in S504 described in FIG. 5 and displaying the menu screen on the display unit 161 in S510. Since the menu screen is displayed on the display unit 161, the communication apparatus 151 is in a state of being able to accept operations by the user. In S601, the CPU 154 accepts an operation instruction from the user. The operation instruction is accepted via the operation unit 159 of the communication apparatus 151. After S602, different processes are performed depending on the content of the operation instruction.

In S602, the CPU 154 determines whether the operation instruction is to power off the communication apparatus 151. If the user performs an operation to power off the communication apparatus 151, the CPU 154 proceeds to S603. In S603, the CPU 154 executes processing to power off the communication apparatus 151. In response to this power-off processing, the operation in the restricted mode is also terminated. Then, the CPU 154 ends the processing of the flowchart shown in FIG. 6. If determining that the operation instruction is not an operation to power off the communication apparatus 151, the CPU 154 proceeds to S604.

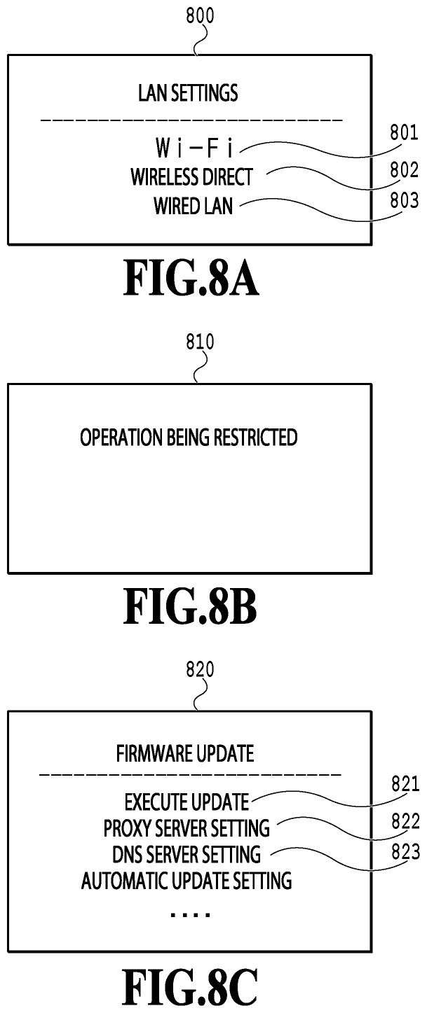

In S604, the CPU 154 determines whether the operation instruction is to update the firmware of the communication apparatus 151. A screen display for updating the firmware will be described in detail later with reference to FIGS. 8 and 9. Upon receiving the user's operation instruction for updating the firmware of the communication apparatus 151, the CPU 154 proceeds to S605. In S605, the CPU 154 shifts the communication apparatus 151 to a firmware update mode. The firmware update mode is a mode for performing network communication with an external server that manages the latest firmware, in order to update the firmware of the communication apparatus 151. In this mode, a printing operation using the print engine 155, and the like are not available. More specifically, in the firmware update mode, the network communication is only performed with an external server that manages the latest firmware, and processing such as the log information transmission shown in FIG. 2 and the communication check transmission shown in FIG. 3 is not performed. In other words, the firmware update mode can be said to be a mode only for updating the firmware.

If the communication apparatus 151 receives a firmware update operation instruction while operating in the normal mode, the communication apparatus 151 compares the current firmware version with the latest firmware version stored in the external server. Then, only if the versions are different, the CPU 154 shifts the communication apparatus 151 to the firmware update mode. On the other hand, as described in the processing of FIG. 6, if the communication apparatus 151 receives a firmware update operation instruction while operating in the restricted mode, the network settings of the communication apparatus 151 are disabled as described above. Therefore, in S605, the CPU 154 shifts the communication apparatus 151 to the firmware update mode without comparing the firmware versions. That is, in the present embodiment, the CPU 154 can display a screen for updating the firmware shown in FIG. 8C in both cases where the communication apparatus 151 is operating in the normal mode and where the communication apparatus 151 is operating in the restricted mode. However, the CPU 154 controls the processing executed upon receiving a firmware update operation instruction to partially differ between the case where the communication apparatus 151 is operating in the normal mode and the case where the communication apparatus 151 is operating in the restricted mode. In other words, the CPU 154 performs control such that a process that is executed upon receiving a firmware update operation instruction during the operation in the normal mode is partially different from a process that is executed upon receiving a firmware update operation instruction during the operation in the restricted mode. The external server that manages the latest firmware and that is the communication partner of the communication apparatus 151 for updating the firmware is different from the communication partner in the processing shown in FIG. 2 or 3, but may be the same.

Here, in a case of shifting to the firmware update mode in S605, the network settings of the communication apparatus 151 operating in the restricted mode up to this point remain disabled. Therefore, at this point, the communication apparatus 151 cannot perform network communication. To solve this, in S606, the CPU 154 changes the network settings of the communication apparatus 151 so that it operates according to the past network settings (first setting value) saved in the non-volatile memory in S505 of FIG. 5. That is, the network settings are changed to those saved in the non-volatile memory. Specifically, the network settings (for example, the wireless infrastructure connection enable/disable setting) changed from enable to disable in S506 are changed from disable to enable. Subsequently, in S606, the CPU 154 performs network communication with the external server that manages the latest firmware. Specifically, the CPU 154 obtains the latest firmware from the external server, and updates the firmware of the communication apparatus 151 based on the obtained information. Then, the CPU 154 ends the processing shown in FIG. 6. Once the firmware is updated, the communication apparatus 151 is restarted. That is, the communication apparatus 151 is powered off once and then automatically activated again. Upon restart, the communication apparatus 151 is activated in the same mode (the normal mode or the restricted mode) as the mode upon receiving the firmware update operation instruction. However, the present disclosure is not limited to this configuration. Upon restart, the communication apparatus 151 may always be activated in the normal mode.

If determining in S604 that the operation instruction is not an operation instruction to update the firmware of the communication apparatus 151, the CPU 154 proceeds to S607.

In S607, the CPU 154 determines whether the operation instruction is to change the network settings of the communication apparatus 151. If determining that the operation instruction through the user operation is not an instruction to change the network settings, the CPU 154 proceeds to S608. In S608, the CPU 154 operates the communication apparatus 151 based on the operation instructed by the user. Then, the processing returns to S601 and continues the processing shown in FIG. 6. On the other hand, if determining that the operation instruction through the user operation is an instruction to change the network settings, the CPU 154 proceeds to S609. In S609, the CPU 154 displays a screen on the display unit 161 indicating that the settings cannot be changed because the network usage is restricted. This screen will be described in detail later with reference to FIG. 8. Then, the CPU 154 returns to S601 and continues the processing of FIG. 6.

### <Display Screen>

FIGS. 7A, 7B, 8A to 8C, and 9A to 9C are diagrams showing examples of screens displayed on the display unit 161 of the communication apparatus 151. In the present embodiment, the display unit 161 is assumed to be a touch panel.

FIG. 7A shows a menu screen 700 that is first displayed when the communication apparatus 151 is powered on and normally activated. The menu screen 700 is also referred to as a home screen. A logo screen or the like may be displayed before the menu screen 700 of FIG. 7A is displayed. FIG. 7A is an example of a first screen that can accept operation instructions from the user. In the present embodiment, in a case where the communication apparatus 151 is activated in the normal mode in FIG. 4, the menu screen 700 is displayed in S405. The menu screen 700 is also displayed as the menu screen displayed in S510 of FIG. 5. That is, in the present embodiment, the menu screen displayed upon activation in the normal mode and the menu screen displayed upon activation in restricted mode are the same screen. As for a submenu screen or settings screen that is further displayed in a hierarchical manner from the menu screen 700 is basically the same screen for the normal mode and the restricted mode. However, as will be described later, as for the function restricted screen, different screens are displayed between the restricted mode and the normal mode. The menu screen displayed upon activation in the normal mode may be different from the menu screen displayed upon activation in the restricted mode. Specifically, an icon or a message for notifying the user that the apparatus is operating in the restricted mode may be displayed on the menu screen that is displayed upon activation in the restricted mode, for example. The menu screen displayed in S503 in another mode (for example, the inspection mode) different from the normal mode or the restricted mode may be the menu screen 700 or another screen (not shown).

The menu screen 700 has an area where functions of the communication apparatus 151 (for example, copy, scan, and print) can be selected. If any of these functions are selected, the communication apparatus 151 performs processing to execute the corresponding function or displays a screen for setting the corresponding function.

The menu screen 700 displays an area 701 and an area 702. The area 701 is an area where an icon is displayed indicating whether the infrastructure connection or the P2P connection is enabled, based on the network settings of the communication apparatus 151. In S405 of FIGS. 4 and S503 of FIG. 5, the communication apparatus 151 is operating in a mode (for example, the normal mode) other than the restricted mode. Therefore, the icons displayed in the area 701 include an icon indicating the enable setting and an icon indicating the disable setting. In S510 of FIG. 5, on the other hand, the communication apparatus 151 is operating in the restricted mode. Therefore, the icon displayed in the area 701 indicate the disable setting. In the area 702, an icon for changing the settings of the communication apparatus 151 is displayed.

Upon detecting that the area 702 of the menu screen 700 is pressed by the user, the communication apparatus 151 displays a display screen 703 of FIG. 7B. The display screen 703 displays items whose settings can be changed in the communication apparatus 151. In an area 704, a text for changing the network settings of communication apparatus 151 is displayed. In an area 705, a text for updating the firmware of communication apparatus 151 is displayed. Upon detecting that area 704 is pressed by the user, the communication apparatus 151 displays a display screen 800 in FIG. 8A. The display screen 800 is a screen for configuring communication settings for the communication apparatus 151. The communication settings for the communication apparatus 151 include communication settings based on the IEEE802.11 series and communication settings based on the wired LAN. The display screen 800 has an area 801, an area 802, and an area 803. In the area 801, a text for changing the wireless infrastructure connection settings of the communication apparatus 151 is displayed. In the area 802, a text for changing the wireless P2P connection settings of the communication apparatus 151 is displayed. In the area 803, a text for changing the wired infrastructure connection settings of the communication apparatus 151 is displayed. Here, upon detecting that the area 801 is pressed by the user, the communication apparatus 151 can change the setting for enabling or disabling the wireless infrastructure connection, the setting for enabling or disabling the communication protocol used for network communication in the wireless infrastructure connection, and the like. That is, it is possible to display a screen (not shown) for changing these network settings. However, in the present embodiment, these network settings can be changed if the communication apparatus 151 is operating in the normal mode. Upon detecting that the area 801 is pressed by the user in a case where the communication apparatus 151 is operating in the restricted mode and, the communication apparatus 151 displays a screen different from that in the normal mode. That is, a display screen 810 shown in FIG. 8B is displayed, instead of the screen for changing the network settings described above. The display screen 810 displays a text indicating that the operation is restricted, that is, a text indicating that the network settings cannot be changed. After a certain period of time passes with the display screen 810 being displayed, the display screen 800 of FIG. 8A is displayed again. Alternatively, upon detecting that the display screen 810 is pressed by the user or an OK button (not shown) is pressed, the display on the display unit 161 may be switched from the display screen 810 of FIG. 8B to the display screen 800 of FIG. 8A. Note that the present disclosure is not limited to the above configuration. For example, while the communication apparatus 151 is operating in the restricted mode, the area 801, the area 802, and the area 803 may be grayed out. Specifically, a configuration may be adopted in which even if the area 801, the area 802, and the area 803 are pressed, no processing is executed based on the pressing. For example, while the communication apparatus 151 is operating in the restricted mode, the display screen 810 may be displayed, instead of the display screen 800, if the area 704 is pressed. Alternatively, a configuration may be adopted in which while the communication apparatus 151 is operating in the restricted mode, for example, the area 704 is grayed out, so that even if the area 704 is pressed, no processing is executed based on the pressing.

Upon detecting that the area 705 displayed on the display screen 703 in FIG. 7B is pressed by the user, the communication apparatus 151 displays a display screen 820 in FIG. 8C. The display screen 820 has an area 821, an area 822, an area 823, and the like. In the area 821, a text indicating the execution of firmware update of the communication apparatus 151. Upon detecting that the area 821 is pressed by the user, the communication apparatus 151, if operating in the normal mode, starts communication with the external server where the firmware is installed. Specifically, the communication apparatus 151 obtains through the communication information indicating the latest firmware version managed by the external server. Then, the firmware version of the communication apparatus 151 and the latest firmware version managed by the external server are compared based on the obtained information. If it is determined through the comparison that there is a difference between the versions, the communication apparatus 151 shifts to the firmware update mode. If it is determined through the comparison that the versions are the same, the communication apparatus 151 displays a display screen 900 in FIG. 9A without shifting to the firmware update mode. On the other hand, upon detecting that the area 821 is pressed by the user while the communication apparatus 151 is operating in the restricted mode, the communication apparatus 151 does not perform communication to obtain information about the latest firmware version managed by the external server. The communication apparatus 151 then forcibly shifts to the firmware update mode without comparing the firmware version of the communication apparatus 151 with the latest firmware version managed by the external server.

In the area 822, settings can be made for a proxy server in a case where the communication apparatus 151 updates the firmware. Upon detecting that the area 822 is pressed by the user, the communication apparatus 151 shifts to a proxy server settings screen if operating in the normal mode. On the other hand, if the communication apparatus 151 is operating in the restricted mode, the display screen 810 of FIG. 8B is displayed and the settings cannot be changed. In the area 823, settings can be made for a DNS server in a case where the communication apparatus 151 updates the firmware. Upon detecting that the area 823 is pressed by the user, the communication apparatus 151 shifts to a DNS server settings screen if operating in the normal mode. On the other hand, if the communication apparatus 151 is operating in the restricted mode, the display screen 810 of FIG. 8B is displayed and the settings cannot be changed. Once the settings are completed on the settings screen displayed if the area 822 or the area 823 is operated, the communication apparatus 151 may execute a test communication process. Specifically, the test communication process may be executed in which communication with the external server that manages the latest firmware is tested according to the settings on the settings screen. The processing executed if the communication apparatus 151 is operating in the restricted mode is not limited to the above configuration. For example, the area 822 and the area 823 may be grayed out while communication apparatus 151 is operating in the restricted mode. Specifically, a configuration may be adopted in which even if the area 822 and the area 823 are pressed, no processing is executed based on the pressing.

FIG. 9B shows a screen for checking with the user whether to activate the communication apparatus 151 with the restricted network, in a case where the communication apparatus 151 starts operating in the restricted mode. In the present embodiment, a display screen 910 in FIG. 9B is displayed in S507 of FIG. 5. The display screen 910 has an area 911 and an area 912. The area 911 is an area for accepting a user instruction to permit operation in the restricted mode. The area 921 is an area for accepting a user instruction to reject operation in the restricted mode. Upon detecting that the area 911 is pressed by the user, the communication apparatus 151 proceeds to the process of S510 in FIG. 5. On the other hand, upon detecting that the area 921 is pressed by the user, the communication apparatus 151 proceeds to the process of S509 in FIG. 5 and executes processing for turning off the power of the communication apparatus 151.

As described above, according to the present embodiment, the communication apparatus can be operated in an appropriate mode. For example, even if an error occurs, the communication apparatus can be used appropriately. In other words, even if an error occurs in the communication apparatus, it is made possible to operate the communication apparatus with some functions available, and also to update the firmware of the communication apparatus even if only some functions are available. For example, an error as described in FIG. 2 or 3 may occur in the communication apparatus 151. Even in such a case, by operating the communication apparatus 151 in the restricted mode, in which some of the functions are restricted, described in FIGS. 5 and 6, it is possible to prevent a situation where the user cannot use the communication apparatus 151 at all. Such an error may be caused by the firmware of the communication apparatus 151. Even in such a case, by saving the network settings just before shifting to the restricted mode in the non-volatile memory as described in FIG. 6, the firmware can be updated using the external server and the network communication.

### Other Embodiments

In the embodiment described above, in a case where the communication apparatus 151 operates in the restricted mode, the wireless infrastructure connection and wireless P2P connection settings are disabled and the communication with the external apparatus 101 using a USB is possible. However, the USB communication may also be disabled. Alternatively, the communication apparatus 151 may be operated in a state where only the infrastructure connection is disabled and the wireless P2P connection and the USB connection are enabled. In this case, only the infrastructure connection settings may be saved in the network enable/disable settings to be saved. In the restricted mode, the wired infrastructure connection may be disabled or enabled.

In the embodiment described above, if the network communication is disabled and the USB communication is enabled, it is possible to change the settings of the communication apparatus 151 from the external apparatus 101 through the USB communication. In this event, settings other than the network settings can be changed, but the network settings cannot be changed. The settings other than the network settings include, for example, resolution setting, paper feed port setting, power saving setting, and the like in a case where the communication apparatus 151 performs printing.

In the embodiment described above, the description is given of the example where the user operation for activation in the normal mode (an operation that triggers activation in the normal mode) is different from the user operation for activation in the restricted mode (an operation that triggers activation in the restricted mode). The description is also given of the example where the determination between the activation in the normal mode and the activation in the restricted mode is made based on the content of the user operation. However, the user operation for the activation in the normal mode may be the same as the user operation for the activation in the restricted mode. Specifically, for example, the user operation for the activation in the normal mode may be the same as the user operation for the activation in the restricted mode may both be an operation of pressing the power button. In this case, the determination between the activation in the normal mode and the activation in the restricted mode may be made based on error information such as whether an error occurred in the communication apparatus 151 before a user operation to activate the communication apparatus 151, causing the communication apparatus 151 to shut down. That is, if the power button is pressed in a state where error information is stored in the non-volatile memory, indicating that an error just occurred in the communication apparatus 151, causing the communication apparatus 151 to shut down, this can be treated as the acceptance of the instruction to activate in the restricted mode. On the other hand, if the power button is pressed in a state where the error information is not stored in the non-volatile memory, indicating that an error just occurred in the communication apparatus 151, causing the communication apparatus 151 to shut down, this can be treated as the acceptance of the instruction to activate in the normal mode. Note that the error mentioned above is, for example, a communication error, and more specifically, an error that occurs in the processing shown in FIG. 2 or FIG. 3, for example.

In the embodiment described above, upon receiving an instruction to activate in the restricted mode, a process is performed to display a confirmation screen on the display unit 161 to check with the user whether the communication apparatus 151 may operate in the restricted mode. However, the present disclosure is not limited to this configuration. Even if an instruction to activate in the restricted mode is received, the activation and operation in the restricted mode may be executed without displaying the confirmation screen. Here, it is assumed, for example, that the user operation for activation in the normal mode and the user operation for activation in the restricted mode are the same, and the confirmation screen is not displayed. In such a case, the user may not be able to easily determine whether the communication apparatus 151 is activated in the normal mode or restricted mode. Therefore, for example, an icon, a message or the like for showing the user that the communication apparatus is operating in the restricted mode may be displayed on the menu screen displayed in a case where the communication apparatus is activated in the restricted mode.

In the embodiment described above, the description is given of the process of determining whether the network settings allow communication with the server in S406 of FIG. 4. The description is also given of an example where such network settings are for the infrastructure connection. However, the network settings that allow communication with the server may be settings for P2P connection. In this case, the apparatus at the other end of the P2P connection may be treated as the server. In the P2P connection, for example, it is possible to connect to a device equipped with an OS such as Windows (registered trademark) or MacOS (registered trademark). If the operation of such an OS changes due to version upgrade, an error may occur. Even in such a case, by performing the processing according to the embodiment described above, the communication apparatus 151 can be appropriately used even if an error occurs in the communication apparatus 151.

In the embodiment described above, the description is given of the example where the menu screen and the settings screen are displayed on the display unit 161 of the main body of the communication apparatus 151. However, a configuration is also conceivable in which an external host PC or the like remotely connects to the communication apparatus 151 and changes the settings of the communication apparatus 151. In such a configuration, as in the above embodiment, the host PC may also be configured to not accept an operation to change the network settings in the case of the restricted mode.

In the embodiment described above, the description is given of the example where the communication apparatus 151 in the restricted mode shifts to the firmware update mode without checking the firmware version, but the present disclosure is not limited thereto. For example, if it is determined in S604 that there is a firmware update operation, the communication apparatus 151 may display a screen containing a predetermined message. The predetermined message may be, for example, a message indicating that the firmware may be of the same version or that update may take time. Then, upon receiving a user instruction for permission, the communication apparatus 151 may be shifted to the firmware update mode in S605.

In the embodiment described above, the description is given of the configuration in which the restricted mode not only prevents the communication apparatus 151 from performing the process of S407 but also prevents the communication apparatus 151 from performing communication processes other than S407 by changing the network settings of the communication apparatus 151. However, the present disclosure is not limited to this configuration. The restricted mode may be a mode that prevents the communication apparatus 151 from performing the process of S407, but allows the communication apparatus 151 to perform communication processes other than S407. In this configuration, if the communication apparatus 151 is activated in the restricted mode, the process of S407 needs only be simply skipped. Therefore, even if the communication apparatus 151 is activated in the restricted mode, there is no need to change the network settings of the communication apparatus 151. Further, even if the communication apparatus 151 is activated in the restricted mode, there is no need to perform the process of displaying the display screen 810 of FIG. 8B or graying out the items on the screen of FIG. 8A or 8C in a case where an operation is performed on the screen of FIG. 8A or 8C. Specifically, even if the communication apparatus 151 is activated in the restricted mode, the same processing as in the case of operation in the normal mode may be executed as the display processing of the screen of FIG. 8A or 8C and the processing in a case where an operation on the screen is accepted. Examples of the communication processing other than S407 include processing of receiving a print job via a network and test communication executed after the area 822 or the area 823 is selected.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-069399, filed Apr. 20, 2023, which is hereby incorporated by reference wherein in its entirety.

What is claimed is:

1. A communication apparatus capable of operating in a first mode that allows predetermined communication with an external apparatus and operating in a second mode in which the predetermined communication is not executed, comprising:
an acceptance unit configured to accept from a user an activation operation for activating the communication apparatus;
an activation unit configured to activate the communication apparatus in the first mode or the second mode based on acceptance of the activation operation; and
a communication unit configured to automatically execute the predetermined communication without any user operation on the communication apparatus after the activation operation is accepted, based on the activation of the communication apparatus in the first mode, and also configured to not execute the predetermined communication based on the activation of the communication apparatus in the second mode.

2. The communication apparatus according to claim 1, wherein
in a case where the communication apparatus is activated in the first mode and network settings of the communication apparatus allow the predetermined communication to be executed, the predetermined communication is automatically executed based on the activation of the communication apparatus in the first mode, but
in a case where the communication apparatus is activated in the first mode and the network settings of the communication apparatus do not allow the predetermined communication to be executed, the predetermined communication is not automatically executed based on the activation of the communication apparatus in the first mode.

3. The communication apparatus according to claim 2, wherein
the settings that allow the predetermined communication to be executed are settings that allow connection between an external access point located outside the communication apparatus and the communication apparatus.

4. The communication apparatus according to claim 1, further comprising:
a display unit configured to display a predetermined confirmation screen based on the activation operation that triggers activation of the communication apparatus in the second mode; and
a control unit configured to control the communication apparatus to operate in the second mode based on the fact that a first operation is performed in a state where the predetermined confirmation screen is displayed, and also configured to control the communication apparatus not to operate in the second mode based on the fact that a second operation is performed in a state where the predetermined confirmation screen is displayed.

5. The communication apparatus according to claim 4, wherein
the communication apparatus is controlled not to operate in the second mode in a case where the communication apparatus is powered off or in a case where the communication apparatus is activated in the first mode.

6. The communication apparatus according to claim 1, wherein
the external apparatus is at least one of a server that collects log information of the communication apparatus and a server that manages print jobs to be executed in the communication apparatus.

7. The communication apparatus according to claim 1, wherein
in a state where the communication apparatus is operating in the second mode, even if an operation for the predetermined communication settings is accepted, the predetermined communication settings are controlled not to be executed, or the operation for the predetermined communication settings is controlled not to be accepted.

8. The communication apparatus according to claim 7, wherein
the predetermined communication settings include at least one of communication settings based on the IEEE802.11 series and communication based on a wired LAN.

9. The communication apparatus according to claim 1, further comprising:
a second communication unit configured to perform communication for updating firmware of the communication apparatus if an operation for updating the firmware of the communication apparatus is performed in a state where the communication apparatus is operating in the second mode; and
an update unit configured to update the firmware of the communication apparatus based on communication for updating the firmware of the communication apparatus.

10. The communication apparatus according to claim 9, wherein
if the operation for updating the firmware of the communication apparatus is performed in a state where the communication apparatus is operating in the first mode, communication is performed to compare a firmware version of the communication apparatus and the latest firmware version, and then,
the firmware of the communication apparatus is updated if the firmware version of the communication apparatus is different from the latest firmware version, and
if the operation for updating the firmware of the communication apparatus is performed in a state where the communication apparatus is operating in the second mode, the firmware of the communication apparatus is updated without performing communication to compare the firmware version of the communication apparatus and the latest firmware version.

11. The communication apparatus according to claim 9, wherein
a communication standard used for the predetermined communication and a communication standard used for the communication to update the firmware of the communication apparatus are the same predetermined communication standard,
if the activation operation that triggers activation of the communication apparatus in the second mode is accepted, a first setting value set before the activation operation is accepted is saved in the predetermined communication standard settings,
after the first setting value is saved, the value set in the predetermined communication standard settings is changed to a second setting value corresponding to a setting for not performing the predetermined communication, and
if the operation for updating the firmware of the communication apparatus is performed in a state where the communication apparatus is operating in the second mode, the saved first setting value is used to perform the communication for updating the firmware of the communication apparatus.

12. The communication apparatus according to claim 9, wherein
if the firmware of the communication apparatus is updated by executing the operation for updating the firmware of the communication apparatus in a state where the communication apparatus is operating in the second mode, the communication apparatus is restarted and the communication apparatus is activated in the first mode upon the restart.

13. The communication apparatus according to claim 1, wherein
the first mode is at least one of a mode in which communication with an external apparatus via a network other than the predetermined communication is not executed and a mode in which communication settings based on the IEEE 802.11 series are disabled.

14. The communication apparatus according to claim 1, wherein
if the activation operation that triggers activation of the communication apparatus in the second mode is accepted, a first setting value set before the activation operation is accepted is saved in the predetermined communication settings, and
after the first setting value is saved, the value set in the predetermined communication settings is changed to a second setting value corresponding to a setting for not performing the predetermined communication.

15. The communication apparatus according to claim 14, wherein
if the communication apparatus is activated in the first mode after the first setting value is saved and the operation of the communication apparatus in the second mode is terminated, the value set in the predetermined communication settings is changed to the saved first setting value.

16. The communication apparatus according to claim 1, wherein
the activation operation that triggers activation of the communication apparatus in the first mode is different from the activation operation that triggers activation of the communication apparatus in the second mode.

17. The communication apparatus according to claim 1, wherein
the activation operation that triggers activation of the communication apparatus in the first mode is the same as the activation operation that triggers activation of the communication apparatus in the second mode,
whether to activate the communication apparatus in the first mode or the second mode if a user operation for activating the communication apparatus is accepted is controlled based on whether a communication error occurs in the communication apparatus before the user operation for activating the communication apparatus is accepted.

18. The communication apparatus according to claim 1, further comprising:
a print unit configured to execute printing.

19. A method for controlling a communication apparatus capable of operating in a first mode that allows predetermined communication with an external apparatus and operating in a second mode in which the predetermined communication is not executed, comprising:
accepting from a user an activation operation for activating the communication apparatus;
activating the communication apparatus in the first mode or the second mode based on acceptance of the activation operation; and
automatically executing the predetermined communication without any user operation on the communication apparatus after the activation operation is accepted, based on the activation of the communication apparatus in the first mode, and not executing the predetermined communication based on the activation of the communication apparatus in the second mode.

20. A non-transitory computer readable storage medium storing a program which causes a computer of a communication apparatus capable of operating in a first mode that allows predetermined communication with an external apparatus and operating in a second mode in which the predetermined communication is not executed to execute:
accepting from a user an activation operation for activating the communication apparatus;
activating the communication apparatus in the first mode or the second mode based on acceptance of the activation operation; and
automatically executing the predetermined communication without any user operation on the communication apparatus after the activation operation is accepted, based on the activation of the communication apparatus in the first mode, and not executing the predetermined communication based on the activation of the communication apparatus in the second mode.
